(19) United States
(12) Patent Application Publication
(10) Pub. No.: US 2009/0104469 A1
(43) Pub. Date: Apr. 23, 2009

(54) METHOD FOR FABRICATING A MOLDING COIL STRUCTURE AND A MOLDING COIL STRUCTURE

(75) Inventor: Huo-Li Lin, TAIPEI (TW)

Correspondence Address: PAI PATENT & TRADEMARK LAW FIRM, 1001 FOURTH AVENUE, SUITE 3200, SEATTLE, WA, 98154, US

(73) Assignee: TRIO TECHNOLOGY CO., LTD., TAIPEI (TW)

(21) Appl. No.: 12/042,324

(22) Filed: Mar. 4, 2008

(30) Foreign Application Priority Data
Oct. 18, 2007 (TW) 96139063

(51) Int. Cl. B32B 15/02; B22F 7/04

(52) U.S. Cl. 428/557; 419/66

(57) ABSTRACT

A method for fabricating a molding coil structure and a molding coil structure are provided. Forming at least one metal wire into a metal coil; forming a metal powder pillar with a high-pressure fabrication process; placing the metal powder pillar into a center of the metal coil; placing the metal coil and the metal pillar into a mold and stuffing a plurality of metal powder particles with high-pressure to form a covering structure surrounding and contacting the metal powder pillar and the metal coil to form the molding coil structure.

### RELATED APPLICATIONS

This application claims priority to Taiwan Application Serial Number 96139063, filed Oct. 18, 2007, which is herein incorporated by reference.

### BACKGROUND

1. Field of Invention

The present invention relates to a molding coil structure. More particularly, the present invention relates to a method for fabricating a molding structure coil.

2. Description of Related Art

Inductors are important elements of electronic circuits. Inductors can be used to store and release energy. Inductors eliminate disturbance from magnetic fields therefore making them ideal for implementation in today's shrinking electronic products. Many countries are making rules to set up a standard for the inductors. The inductor has thus becomes an important element of the electronic circuits.

The conventional method for fabricating an inductor with the molding coil structure is depicted in FIG. 1A. First, a metal wire is wound to form a metal coil 10. The metal coil 10 is placed into a mold and is stuffed with a plurality of iron powder particles. Then a high-pressure process with a pressure of about 15-20 tons/square inch is performed to compress the metal coil 10 and the iron powder particles. FIG. 1B illustrates a perspective view of an inductor element. After the high-pressure process is complete, a covering structure 11 is formed, a. The covering structure 11 forms the inductor element. The process described above has to take the metal wire 10 into consideration. The metal wire 10 is primarily made of copper. Copper cannot stand very high-pressures during the process of stuffing inductor with iron particles. Thus there is a limit to the pressure exerted in the above process in order not to break the metal coil 10 to decrease the performance of the inductor. But if the iron powder could be formed under even higher pressures, the density of the powder would be greatly increased and the performance of the inductor would also be increased. The trade-off described above makes improving inductor performance difficult.

Accordingly, what is needed is a molding coil structure and a method for fabricating a molding coil structure to overcome the above issues. The present invention addresses such a need.

### SUMMARY

The present invention is directed to a method of fabricating a molding coil structure comprising the steps of forming at least one metal wire into a metal coil; forming a metal powder pillar with a high-pressure fabrication process; placing the metal powder pillar into the center of the metal coil; placing the metal coil and the metal pillar into a mold; and stuffing a plurality of metal powder particles with high-pressure to form a covering structure surrounding and contacting the metal powder pillar and the metal coil to form the molding coil structure.

It is another objective of the present invention to provide a molding coil structure comprising a metal coil; a metal powder pillar placed in a center of the metal coil; and a covering structure comprising a plurality of metal powder particles, wherein the covering structure covers the metal coil and the metal powder pillar.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a 3-dimensional view of a metal coil in the prior art;

FIG. 1B is a perspective view of a packed inductor element in the prior art;

FIG. 2 is a perspective view of a molding coil structure of the first embodiment of the present invention;

FIG. 3 is a perspective view of a molding coil structure of the second embodiment of the present invention;

FIG. 4 is a flow chart of the third embodiment of the present invention; and

FIG. 5 is a flow chart of the forth embodiment of the present invention.

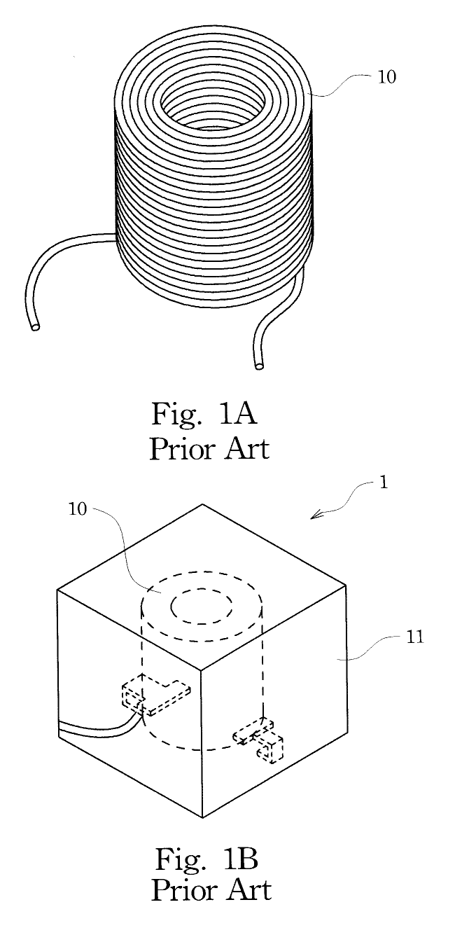

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

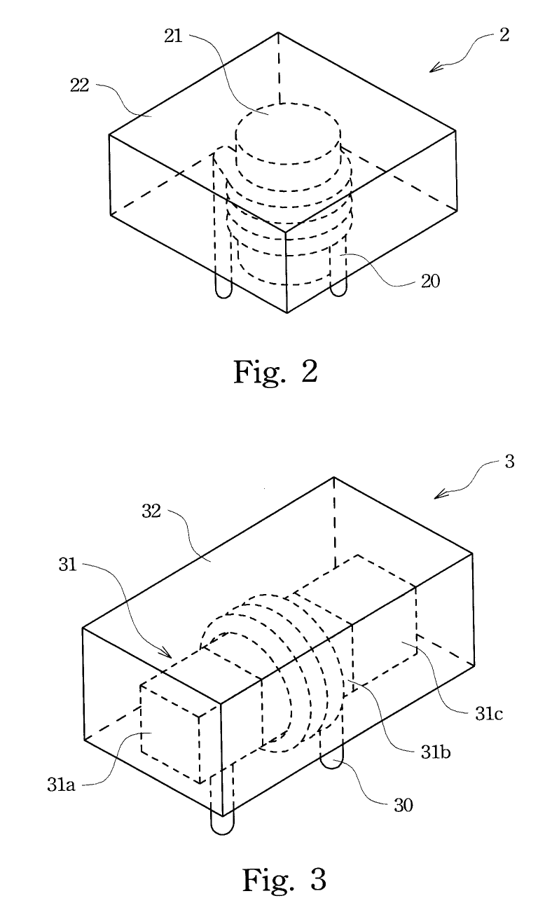

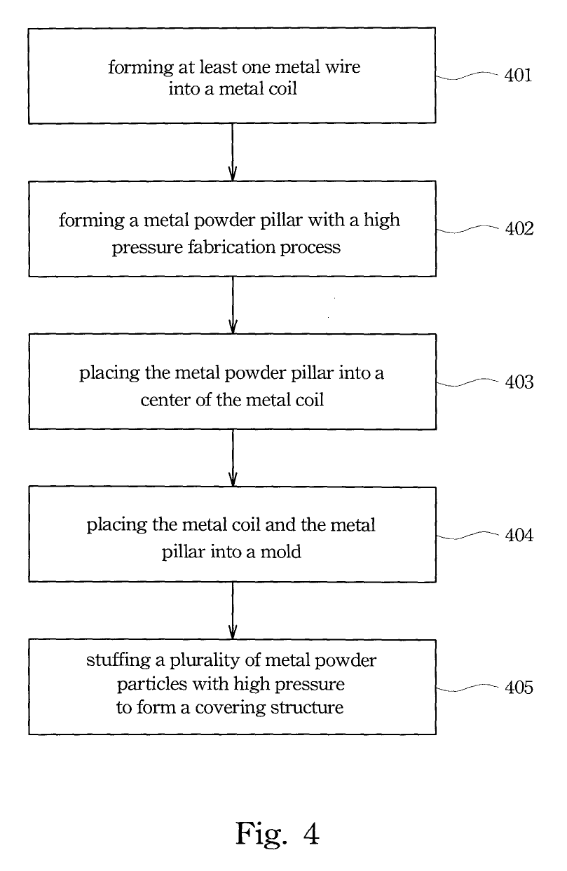

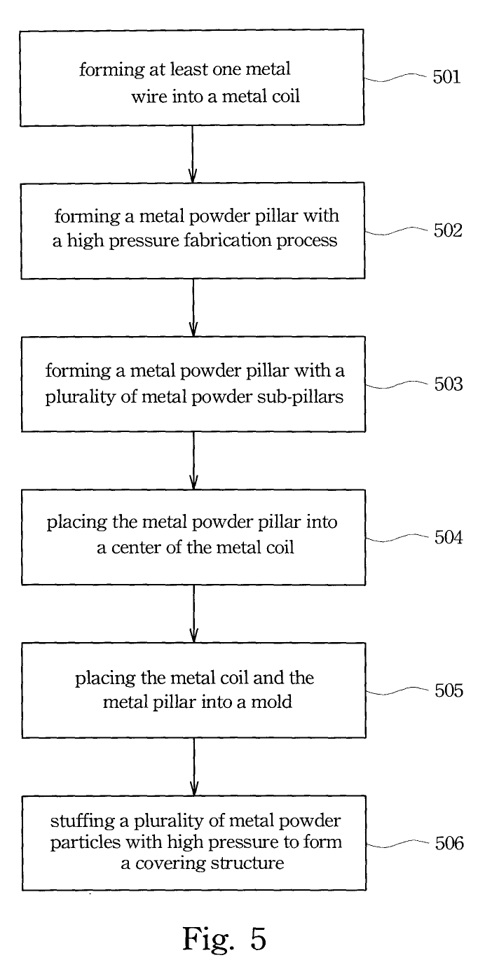

Please refer to FIG. 2. FIG. 2 is a perspective view of a molding coil structure 2 of a first embodiment of the present invention. The molding coil structure 2 comprises a copper coil 20, a round iron powder pillar 21 and a covering structure 22. In the present embodiment, the coil 20 is made with copper wire. In other embodiments, the coil can be made not only of copper but also of other metals, and more than one wire can be used to form the coil and improve the performance. The people skilled in the art can easily make various modifications. Two ends of the copper coil 20 are wound to the same side of the copper coil 20 and is formed in a regular wound way, an irregular wound way or an up down wound way. The round iron powder pillar 21 is formed by a plurality of iron powder particles with a high-pressure process over 25 tons/square inch, and is placed in the center of the copper coil 20, and in the other embodiment, the round iron powder pillar 21 can be a pillar with different shape. The covering structure 22 comprises a plurality of iron powder particles. After erecting the copper coil 20 and the round iron powder pillar 21 vertically and stuffing the plurality of iron powder particles into a mold, a high-pressure process with a direction parallel to the center of the copper coil 20 is performed. The mold fixes the shape and forms the covering structure 22. The two ends of the copper coil 20 are exposed out of the covering structure 22 and are electrically connected to an external circuit.

The round iron powder pillar 21 of the molding coil structure 2 has a very high density. The high density is a result of the high-pressure process over 25 tons/square inch during the formation of the powder pillar. The high density powder pillar at the center of the molding coil structure 2 improves the overall performance of the inductor. The round iron powder pillar 21 further provides a supporting mechanism that enables the copper coil 20 to withstand pressures higher than 20 tons/square inch>, Thus the iron powder particles can increase their density as well to improve the performance of the molding coil structure 2.

Please refer to FIG. 3, a perspective view of a molding coil structure 3 of a second embodiment of the present invention. The molding coil structure 3 comprises a copper coil 30, an iron powder square pillar 31 and a covering structure 32. Two ends of the copper coil 30 are wound to the opposite side of the copper coil 30. The copper coil 30 is formed in a regular wound way, an irregular wound way or an up-down wound way. The iron powder square pillar 31 is placed in the center of the copper coil 30 and is formed by three iron powder sub-square pillars 31a, 31b and 31c. Each of the iron powder sub-square pillars is formed by a plurality of iron powder particles with a high-pressure process over 25 tons/square inch. In the other embodiment, the iron powder square pillar can be formed by a different number of iron powder sub-square pillars. The covering structure 32 comprises a plurality of iron powder particles. After erecting the copper coil 30 and the iron powder square pillar 31 vertically and stuffing the plurality of iron powder particles into a mold, a high-pressure process with a direction parallel to the center of the copper coil 30 is performed. The mold fixes the shape and forms the covering structure 22. The two ends of the copper coil 20 are exposed out of the covering structure 22 and are electrically connected to an external circuit.

The molding coil structure 3 in the first embodiment has a high density iron powder round pillar 31 that results from the high-pressure process in the center and enables the inductor to have an improved performance. The spaces between the iron powder sub-square pillars provide better inductor performance. The iron powder square pillar 31 further provides a supporting mechanism to make the copper coil 30 able to withstand pressures higher than 20 tons/square inch., Thus the iron powder particles can increase their density as well improve the performance of the molding coil structure 3.

The third embodiment of the present invention is a method for fabricating a molding coil structure. First, in step 401 at least one metal wire is formed into a metal coil; in step 402 metal powder pillar is formed with a high-pressure fabrication process; then, in step 403 the metal powder pillar is placed into the center of the metal coil; then, in step 404 the metal coil and the metal pillar are placed into a mold; and in step 405 a plurality of metal powder particles are exposed to high-pressure treatment to form a covering structure surrounding and contacting the metal powder pillar and the metal coil to form the molding coil structure. Two ends of the metal coil are exposed out of the covering structure and are electrically connected to an external circuit.

The fourth embodiment of the present invention is a method for fabricating a molding coil structure. In the first, step 501 at least one metal wire is formed into a metal coil; then, in step 502 a plurality of metal powder sub-pillars are formed with a high-pressure fabrication process. Then, in step 503 a metal powder pillar is formed with a plurality of metal powder sub-pillars; then, in step 504 the metal powder pillar is placed into the center of the metal coil; then, in step 505 the metal coil and the metal pillar are placed into a mold; and in step 506 a plurality of metal powder particles are exposed to a high-pressure to form a covering structure surrounding and contacting the metal powder pillar and the metal coil to form the molding coil structure. Two ends of the metal coil are exposed out of the covering structure and are electrically connected to an external circuit.

The above embodiments show that the metal powder pillar made by a high-pressure process of over 25 tons/square inch has a high density structure and provides a supporting mechanism while stuffing the metal powder particles under high-pressure without breaking the metal coil, further increase the performance of the molding coil structure. Also, the metal powder pillar comprising a plurality of metal powder sub-pillars can improve the performance due to the space between each of the metal powder sub-pillars.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for fabricating a molding coil structure comprising the steps of:
forming at least one metal wire into a metal coil;
forming a metal powder pillar with a high-pressure fabrication process;
placing the metal powder pillar into a center of the metal coil;
placing the metal coil and the metal pillar into a mold; and
stuffing a plurality of metal powder particles with high-pressure to form a covering structure surrounding and contacting the metal powder pillar and the metal coil to form the molding coil structure.

2. The method of claim 1, wherein the pressure of the high-pressure fabrication process forming the metal powder pillar is over 25 tons per square inch.

3. The method of claim 1, wherein the high-pressure fabrication process forming the metal powder pillar further comprising the following step of forming a plurality of metal powder sub-pillars and combing the plurality of metal powder sub-pillars to form the metal power pillar.

4. The method of claim 1, wherein the two ends of the metal coil are exposed out of the covering structure.

5. A molding coil structure comprising:
a metal coil;
a metal powder pillar placed in a center of the metal coil; and
a covering structure comprising a plurality of metal powder particles, wherein the covering structure covers the metal coil and the metal powder pillar.

6. The molding coil structure of claim 5, wherein the metal powder pillar is formed with a high-pressure fabrication process

7. The molding coil structure of claim 6, wherein the pressure of the high pressure fabrication process forming the metal powder pillar is over 25 tons per square inch.

8. The molding coil structure of claim 5, wherein the metal powder pillar comprises a plurality of metal powder sub-pillars.

9. The molding coil structure of claim 5, wherein the two ends of the metal coil are exposed out of the covering structure.

10. The molding coil structure of claim 5, wherein the metal coil is formed with a regular wound way, an irregular wound way or an up-down wound way.
